(19) United States
(12) Patent Application Publication
(10) Pub. No.: US 2025/0182424 A1
(43) Pub. Date: Jun. 5, 2025

(54) INTERACTIVE CONTROL METHOD AND ELECTRONIC DEVICE

(71) Applicant: Lenovo (Beijing) Limited, Beijing (CN)

(72) Inventors: Tengfei WANG, Beijing (CN); Zhipeng YAN, Beijing (CN); Ligang GUO, Beijing (CN)

(21) Appl. No.: 18/965,296

(22) Filed: Dec. 2, 2024

(30) Foreign Application Priority Data
Nov. 30, 2023 (CN) 202311631204.0

(51) Int. Cl. G06T 19/20; G06F 3/01

(52) U.S. Cl. CPC G06T 19/20; G06F 3/017; G06T 2219/2012

(57) ABSTRACT

A control method includes: after obtaining a target user's interactive operation, determining an operated object pointed to by the interactive operation; and, based on a relationship between an action area of the interactive operation and a visual perception area of the target user, controlling display parameters of the operated object by a corresponding control strategy, the visual perception area being a three-dimensional (3D) space area being perceived by the target user when an electronic device displays and outputs 3D object data.

### CROSS-REFERENCES TO RELATED APPLICATION

This application claims priority to Chinese Patent Application No. 202311631204.0 filed on Nov. 30, 2023, the entire content of which is incorporated herein by reference.

### FIELD OF TECHNOLOGY

The present disclosure relates to the field of virtual interaction technology and, more specifically, an interactive control method and an electronic device.

### BACKGROUND

As three-dimensional (3D) display gradually becomes the mainstream display method, 3D content is displayed in a directional manner by using eye tracking technology, which greatly improves the display effect and application feasibility of 3D display.

In current 3D displays, users still need to use devices such as a mouse and a keyboard to operate the display content of the 3D device, resulting in poor user interactions.

### SUMMARY

One aspect of this disclosure provides an interactive control method. The interactive control method includes after obtaining a target user's interactive operation, determining an operated object pointed to by the interactive operation; and, based on a relationship between an action area of the interactive operation and a visual perception area of the target user, controlling display parameters of the operated object by a corresponding control strategy. The visual perception area being a three-dimensional (3D) space area is perceived by the target user when an electronic device displays and outputs 3D object data.

Another aspect of the present disclosure provides an electronic device. The electronic device includes a determination module and a first control module. The determination module is configured to determine an operated object pointed to by an interactive operation after obtaining the interactive operation of a target user. The first control module is configured to control display parameters of the operated object with a corresponding control strategy based on a relationship between an action area of the interactive operation and a visual perception area of the target user. The visual perception area is a three-dimensional (3D) space area being perceived by the target user when the electronic device displays and outputs 3D object data.

Another aspect of the present disclosure provides electronic device including one or more processors and a computer readable storage medium storing computer program instructions that, when executed by the one or more processors, causing the electronic device to perform an interactive control method. The method includes after receiving a target user's interactive operation, determining an operated object pointed to by the interactive operation; and based on a relationship between an action area of the interactive operation and a visual perception area of the target user, controlling display parameters of the operated object by a corresponding control strategy, wherein the visual perception area is a three-dimensional (3D) space area being perceived by the target user when an electronic device displays and outputs 3D object data.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a flowchart of an exemplary interactive control method according to some embodiments of the present disclosure.

FIG. 2 is a schematic diagram showing a relationship between an action area of an interactive operation and a visual perception area of a target user according to some embodiments of the present disclosure.

FIG. 3 is a schematic diagram of a virtual interactive control set in a three-dimensional (3D) space according to some embodiments of the present disclosure.

FIG. 4 is a schematic diagram showing another relationship between the action area of the interactive operation and the visual perception area of the target user according to some embodiments of the present disclosure.

FIG. 5 is a schematic diagram showing some exemplary gesture types according to some embodiments of the present disclosure.

FIG. 6 is a schematic structural diagram of an exemplary electronic device according to some embodiments of the present disclosure.

FIG. 7 is a schematic structural diagram of another exemplary electronic device according to some embodiments of the present disclosure.

### DETAILED DESCRIPTION

Various aspects and features of the present disclosure are described herein with reference to the accompanying drawings.

Obviously, various modifications may be made to embodiments described herein. Thus, the description should not be construed as limiting, but merely as examples of the embodiments. Other modifications within the scope and spirit of the present disclosure will be obtained by those skilled in the art.

The accompanying drawings, which are incorporated in and constitute a part of the specification, illustrate the embodiments of the present disclosure and, together with the general description of the present disclosure given and the detailed description of the embodiments, serve to explain the principle of the present disclosure.

These and other features of the present disclosure will be apparent from the description of the embodiments given as non-limiting examples with reference to the accompanying drawings.

It is further to be understood that, although the present disclosure has been described with reference to specific examples, those skilled in the art will be able to undoubtedly implement many other equivalent forms of the present disclosure, which have the characteristics as claimed and therefore fall within the scope of protection.

Other aspects, features, and advantages of the present disclosure will be apparent in view of the following detailed description when taken in conjunction with the accompanying drawings.

Hereinafter, specific embodiments of the present disclosure will be described with reference to the accompanying drawings. However, it should be understood that the embodiments are merely examples of the present disclosure, which can be implemented in various ways. Well-known and/or repeated functions and structures have not been described in detail to avoid obscuring the description of the present disclosure with unnecessary or redundant detail. Therefore, specific structural and functional details claimed herein are not intended to be limiting, but merely serve as a representative basis for the claims to teach one skilled in the art to utilize the present disclosure in substantially any suitable detailed structure.

This specification may use the phrases “in one embodiment,” “in another embodiment,” “in yet another embodiment,” “in some embodiments,” or “in some other embodiments,” which may refer to the same thing in accordance with the present disclosure, or one or more of the different embodiments.

To facilitate understanding of the present disclosure, the interactive control method provided by the present disclosure is described in detail. Here, the interactive control method according to the embodiment of the present disclosure is applied to an electronic device such as a 3D device, and an executer of the interactive control method according to the embodiment of the present disclosure may be a processor or a controller of the electronic device.

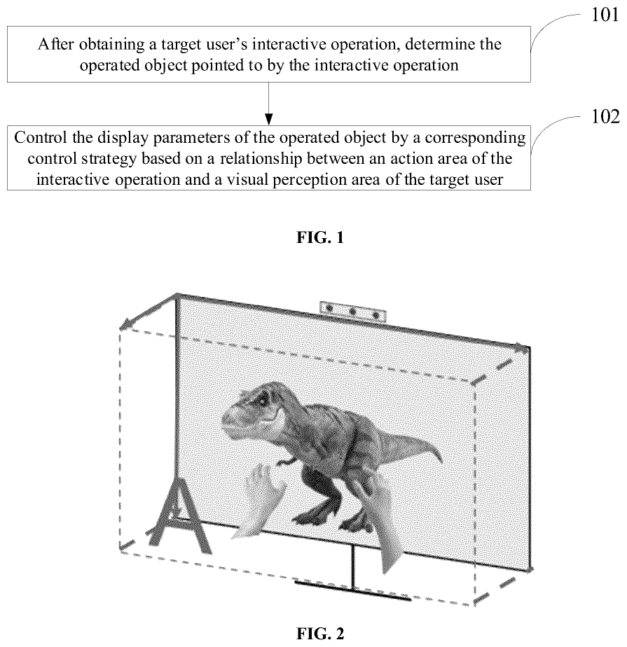

FIG. 1 is a flowchart of an exemplary interactive control method according to some embodiments of the present disclosure. The method will be described in detail below.

101, after obtaining a target user's interactive operation, determining the operated object to which the interactive operation points to.

In a specific implementation, the target user may be any user. For example, when a research object is displayed based on an electronic device such as a naked-eye 3D device, scholars participating in the research (that is, any user) can be the target user. In another example, the target user may also be a specific user who has passed the authentication. For example, when a designer displays an object designed by him/her on an electronic device, in order to prevent other users besides the designer from destroying the object during design process, before executing the steps of the embodiments of the present disclosure, there is a need to authenticate the user and determine the authenticated user (that is, the designer) as the target user. The target user may be set based on actual needs, which is not limited in the embodiments of the present disclosure.

After the target user is determined, the target user's interactive operations can be collected in real time. The interactive operation may include one or more gesture interactive operations, line-of-sight interactive operations, and voice interactive operations. In some embodiments, gesture interactive operations can be collected through cameras, time-of-flight (TOF) cameras, and other devices, line-of-sight interactive operations can be collected through eye trackers and other devices, and voice interactive operations can be collected through microphones and other devices.

In some embodiments, when the electronic device displays and outputs 3D object data, a virtual interactive control (such as a virtual touchpad, a virtual floating ball, etc.) may be output in the 3D space area that can be perceived by the target user. The target user's interactive operation may also include the target user's interactive operation on the virtual interactive control. The interactive operation may be obtained by directly monitoring the changes of the virtual interactive control. Of course, in other embodiments, the virtual interactive control may also not be output along with the data source of the 3D content data, but only rely on the light output module of the electronic device. However, the virtual display control output by the light output module may have a content association relationship with the 3D content data, such as being able to control changes in display parameters of the 3D content data.

After obtaining the target user's interactive operation, the operated object that the interactive operation points to can be determined, the operated object being the object that the target user expects to control. The operated object may be a single object, multiple objects, or the entire display output object. For example, when the object currently being displayed by the electronic device is a dinosaur, the head of the dinosaur can be determined as the operated object, the limbs and tail of the dinosaur can also be determined as the operated object, and the entire dinosaur can also be determined as the operated object, etc.

102, controlling the display parameters of the operated object by a corresponding control strategy based on the relationship between an action area of the interactive operation and a visual perception area of the target user.

When the interactive operation is obtained, the effective area of the interactive operation, that is, the area forming the interactive operation, may also be obtained. Take the interactive operation including gesture interactive operations as an example. When the TOF camera collects gesture interactive operation, it can simultaneously detect the distance (depth information) and the relative angle between itself and the hand that forms the gesture interactive operation based on its ranging principle. Based on the distance (depth information) and the relative angle, the effective area of the interactive operation can be determined.

In some embodiments, when the target user uses the electronic device, the eye tracker on the electronic device can track the target user's line-of-sight and determine the target user's visual perception area based on the display parameters of the electronic device and the target user's line-of-sight. The visual perception area is the 3D space area that can be perceived by the target user when the electronic device displays and outputs 3D object data. The visual perception area may be a 3D display area when the electronic device displays and outputs 3D object data, or may be a 3D space area perceived by a target user, or may be an overlapping area between the 3D object display area and the 3D space area.

In some embodiments, after the action area and the visual perception area of the interactive operation are obtained, the relationship between the action area and the visual perception area may also be determined. The relationship between the action area and the visual perception area may include that the action area is within the visual perception area, the action area is outside the visual perception area, and the action area crosses the edge of the visual perception area.

In some embodiments, after the relationship between the action area and the visual perception area is determined, the display parameters of the operated object may be controlled based on the relationship with the corresponding control strategy. For example, when the relationship indicates that the action area is within the visual perception area, the display parameters of the operated object may be controlled by a local control strategy; when the relationship indicates that the action area is outside the visual perception area, the display parameters of the operated object may be controlled by an overall control strategy. In addition, if there is an overlapping area between the action area and the area corresponding to the virtual interactive control, the display parameters of the interactive operation may be controlled by a control strategy.

In some embodiments, the display parameters of the operated object may include display size, display position, display attitude, etc.

Consistent with the present disclosure, the operated object can be determined based on the obtained interactive operation, and the corresponding control strategy can be determined based on the relationship between the action area of the interactive operation and the visual perception area of the target user. Subsequently, the display parameters of the operated object can be controlled based on the control strategy. That is, different relationships can correspond to different control strategies. In this way, the purpose of interactive control based on interactive operations can be achieved, and different control strategies can be executed based on different actions and visual perception areas, the interactivity is high. In addition, interactive operations can be performed without physical devices, which reduces the limitations of interaction and improves target users' interactive experience.

In the embodiments of the present disclosure, when determining the operated object pointed to by the interactive operation, the operated object pointed to by the interactive operation can be determined by at least one of the following determination methods.

In the first determination method, the coordinate information of the action area of the interactive operation can be determined, and the object matching the coordinate information in the 3D space area can be determined as the operated object. A spatial coordinate system can be constructed based on the 3D display area when the electronic device displays and outputs the 3D object data, or a spatial coordinate system can be constructed based on the 3D space where the electronic device is located. Based on this, while obtaining the interactive operation, the TOF camera can be used to obtain the coordinate information of the action area of the interactive operation in the spatial coordinate system. For example, when the interactive operation is a gesture interactive operation, the TOF camera collects the point cloud image corresponding to the hand, and the point cloud image includes a one-hand gesture or a two-hand gesture. Subsequently, the point cloud image can be analyzed and calculated to obtain the coordinate information of the hand, that is, the coordinate information of the area where the interactive operation is performed. Of course, other TOF cameras, infrared sensor arrays, ultrasonic sensors, etc., can also be used to determine the coordinate information of the action area of the interactive operation. In some embodiments, when the interactive operation is a line-of-sight interactive operation or a voice interactive operation, the above method can also be used to determine the coordinate information of the target user's hand, and then obtain the coordinate information of the action area of the interactive operation.

After the coordinate information of the action area of the interactive operation is determined, an object in the 3D space area that matches the coordinate information can be determined as the operated object. More specifically, when there is an overlapping area between the action area and the visual perception area, the single object or multiple objects displayed and output corresponding to the coordinate information can be determined as the operated objects; when there is no overlapping area between the action area and the visual perception area, the entire displayed output object can be determined as the operated object.

In the second determination method, gesture parameters of the interactive operation can be obtained, and all or part of the objects in the 3D space area can be determined as the operated objects based on the gesture parameters. Different interactive operations can be set for different operated objects. For example, when the interactive operation is a gesture interactive operation, the one-hand gesture can be pre-set to correspond to all objects in the 3D space area (that is, the entire display output object), and the two-hand gesture can be pre-set to correspond to some objects (that is, a single objects or multiple objects displayed output). After the interactive operation is obtained, the gesture parameters of the interactive operation can be determined to determine all or part of the objects in the 3D space area as the operated objects based on the gesture parameters. The gesture parameters here may include the number of hands.

In some embodiments, the gesture parameters of the interactive operation may also include the hand gesture. When one of the two-hand gestures is a fixed gesture, multiple objects in the corresponding part of the object may be the operated objects, which is not limited in the embodiments of the present disclosure.

In the third determination method, when the interactive operation is a voice interactive operation, the semantic content of the voice interactive operation can be identified, and an object with the semantic content can be determined from the 3D space area as the operated object. When the interactive operation is a voice interactive operation, that is, the target user performs the interactive operation through voice, after the target user's voice is obtained, the semantic content of the voice interactive operation can be identified, and the object matching the semantic content can be determined from the 3D space area as the operated object. As an example, the operated object can be determined based on a keyword included in the semantic content.

Of course, the keywords for setting semantic content can be different for different 3D objects displayed and output by the electronic device. For example, when the 3D object to be displayed is an animal, the keyword of the semantic content can be set as limb parts; when the 3D object to be displayed is a new plant to be cultivated, the keyword of the semantic content can be set as color or shape, etc. Of course, corresponding labels can also be set in advance for each of the 3D objects displayed and output. In this case, keywords of semantic contents can be set as labels. For example, if the semantic content of the identified voice interactive operation includes the keyword “dinosaur head”, the head of the dinosaur displayed in the 3D space area will be taken as the operated object.

The embodiments of the present disclosure illustrate the above three determination methods to determine the operated object pointed by the interactive operation, but those skilled in the art should know that the present disclosure is not limited thereto, other method may also be used to determine the operated object pointed by the interactive operation.

In the embodiments of the present disclosure, when the display parameters of the operated object are controlled by a corresponding control strategy based on the relationship between the action area of the interactive operation and the visual perception area of the target user, the control strategy may include at least one of the following three control methods.

In the first control method, if the action area is within the visual perception area, the display parameters of the operated object may be controlled by responding to the interactive operation with a first control strategy. In a specific implementation, if the relationship between the action area of the interactive operation and the visual perception area of the target user is that the action area is within the visual perception area, then the operated object can be determined to be a single object or multiple objects among all objects displayed and output by the electronic device. Subsequently, the first control strategy can be used to respond to the interactive operation to control the display parameters of the operated object, the first control strategy being the local control strategy. FIG. 2 is a schematic diagram showing a relationship between the action area of the interactive operation and the visual perception area of the target user according to some embodiments of the present disclosure. As shown in FIG. 2, area A is the visual perception area of the target user, and the action area of the interactive operation is the area where the hands are located. In FIG. 2, both hands fall into the visual perception area, that is, the action area is within the visual perception area. At this time, the first control strategy can be used to respond to the interactive operation to control the operated object of the operated object. In FIG. 2, the operated object may be the head, limbs, etc., of a dinosaur.

In some embodiments, when the display parameters of the operated object are controlled to respond to the interactive operation with the first control strategy, the first control strategy may include the following exemplary types of controls.

In the first exemplary type of control, the first control strategy may include the corresponding relationship between the operating variables and the mapping variables. The operating variables include unidirectional variables and bidirectional variables. The unidirectional variables correspond to the moving distance, and the bidirectional variables correspond to the scaling factor. Based on this, after obtaining the interactive operation, the operation starting point and the operation end point of the interactive operation can be determined, and the operating variable of the interactive operation can be determined based on the operation starting point and the operation end point.

After the operating variables are determined, the operated object can be controlled to switch from the first display parameter to the second display parameter based on the mapping variables of the operating variables under the first control strategy. For example, when the operating variable is a unidirectional variable, if the unidirectional variable is to move horizontally 2 centimeters (cm) to the right, based on the first control strategy, the mapping variable corresponding to the operating variable will be to move horizontally 2*a cm to the right. Therefore, the operated object is controlled to switch from the first display parameter to the second display parameter. In this example, the difference parameter between the first display parameter and the second display parameter at least includes the display position of the operated object. That is, the operated object is controlled to move horizontally to the right by 2*a cm, where a can be determined based on the electronic device and its corresponding visual perception area. For example, when the operating variable is a bidirectional variable, if the bidirectional variable is 1 cm of opposite movement, based on the first control strategy, the mapping variable corresponding to the operating variable will be to reduce by 2 times. Therefore, the operated object is controlled to switch from the first display parameter to the second display parameter. In this example, the difference between the first display parameter to the second display parameter at least includes the display size and display position of the operated object, that is, the operated object is controlled to be reduced by 2*b times, where b is customized by the target user or set by the manufacturer of the electronic device. Correspondingly, when the operating variable is a bidirectional variable, if the bidirectional variable is a reverse movement of 2 cm, based on the first control strategy, the mapping variable corresponding to the operating variable will be to enlarge by 4 times. At this time, the operated object is controlled to be enlarged 4 times. The specific process is the same as the process of reducing the operated object 2 times, which will not be repeated here.

In the second exemplary type of control, if the interactive operation is used to change the color display attribute of the operated object, the color display parameters of the operated object may be switched based on the color selection of the target user or based on the color relationship between the operated object and other related objects. More specifically, when it is determined that the interactive operation indicates changing the color display attribute of the operated object, the color selected by the target user can be obtained. The target user can transmit the color parameter selected by the target user to the electronic device through voice interactive operation to cause the electronic device to switch the color display parameters of the operated object based on the color selected by the target user. In some embodiments, when it is determined that the interactive operation indicates a change in the color display attribute of the operated object, a related object to the operated object may also be determined. The related object may be an object that is in contact with the edge of the operated object, and there may be one or more related objects of the operated object. Subsequently, the color display parameters of the operated object can be switched based on the color relationship between the operated object and other related objects. The color display parameters of the operated object may be switched preferentially based on the color selection of the target user to accurately meet the interaction needs of the target user.

More specifically, when switching the color display parameters of the operated object based on the color relationship between the operated object and other related objects, if it is determined that the color relationship between the operated object and other related objects is a different color system, the color display parameters of the operated object may be switched such that the difference between the color display parameters of the operated object and the color display parameters of the other related objects is greater than a first threshold. Further, if it is determined that the color relationship between the operated object and other related objects is the same color system, the color display parameters of the operated object may be switched such that the difference between the color display parameters of the operated object and the color display parameters of the other related objects is less than a second threshold. Furthermore, if it is determined that the color relationship between the operated object and other related objects is a matching color system, the color display parameters of the operated object may be switched such that the difference between the color display parameters of the operated object and the color display parameters of the other related objects is greater than or equal to the second threshold and less than or equal to the first threshold. Of course, the embodiments of the present disclosure are not limited to these examples.

In the third exemplary type of control, when the interactive operation is a voice interactive operation, an input variable of the voice interactive operation may be identified, and the display parameters of the operated object may be adjusted based on the input variable. Under voice interactive operation, the target user can transmit more comprehensive interactive content to the electronic device, such as, enlarge the first part by 4 times, flip the third part 180°, etc. Therefore, the semantic content can be directly identified to obtain the input variable, such as enlarging by 4 times, flipping 180°, etc., and the display parameters of the operated object can be adjusted by on the input variable. The input variable may include at least one of a color display attribute, an attitude display attribute, and a display size for changing the operated object.

In the fourth exemplary type of control, when the electronic device displays and outputs a 3D object, a virtual interactive control may also be set in the 3D space such that the target user can interactively control the operated object through the virtual interactive control. The virtual interactive control may be a virtual touchpad, a virtual floating ball, etc. Based on this, when the electronic device displays and outputs 3D object data, it is determined whether a virtual interactive space is output in the 3D space. When the 3D space outputs a virtual interactive control, whether the interactive operation includes an operation of selecting a target virtual interactive control can be determined.

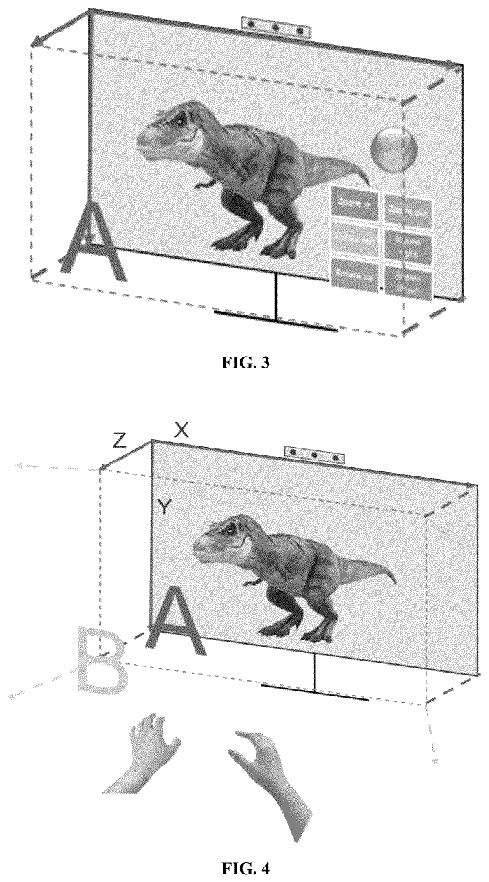

Further, if the interactive operation includes an operation of selecting a target virtual interactive control, the display parameters of the operated object may be adjusted based on the operating variables of the interactive operation and the configuration information of the target virtual interactive control. The configuration information of the target virtual interactive control may include multiple adjustment items such as color, size, position, amplitude change and rate change such that the target user can interactively control the operated object through the target virtual interactive control. FIG. 3 is a schematic diagram of a virtual interactive control set in a 3D space according to some embodiments of the present disclosure. The virtual interactive control in FIG. 3 includes a virtual touchpad and a virtual floating ball, and the display parameters of the operated object can be adjusted based on the configuration information of the target virtual interactive control. By adjusting the display parameters of the operated object through the operating variables of the interactive operation and the configuration information of the target virtual interactive control, the interactivity between the target user and the operated object can be increased to a certain extent to realize the combination of virtual and reality.

It should be noted that the generation of the virtual interactive control may be based on or may not be based on interactions. That is, the virtual interactive control may be generated when the electronic device starts to display and output the 3D object data, or when the target user performs an interactive operation, as long as the target user's use of the virtual interactive control can be satisfied. In some embodiments, the virtual interactive control may be updated based on the type of interactive operation and/or the operated object. That is, different types of interactive operations may correspond to different virtual interactive controls, which in turn adjust different display parameters of the operated object. For example, the display size and display attitude of the operated object can be adjusted through the virtual touchpad, and the display position of the operated object can be adjusted through the virtual floating ball, etc. Of course, different operated objects may also correspond to different virtual interactive controls to adjust display parameters of different operated objects, which will not be described in detail here.

In the second control method, if the action area is outside the visual perception area, a second control strategy may be used to respond to the interactive operation to control the display parameters of the operated object. In a specific implementation, if the relationship between the action area of the interactive operation and the visual perception area of the target user is that the action area is outside the visual perception area, at this time, the operated object can be determined to be the entire display output object of the electronic device, and the second control strategy can be used to respond to the interactive operation to control the display parameters of the operated object. That is, the first control strategy is the overall control strategy.

FIG. 4 is a schematic diagram showing another relationship between the action area of the interactive operation and the visual perception area of the target user according to some embodiments of the present disclosure. In FIG. 4, area B is the area outside the visual perception area of the target user. In this example, the area where the interactive operation is performed is also the area where the hands are located. In FIG. 4, both hands fall outside the visual perception area, that is, the action area is outside the visual perception area. At this time, the second control strategy is used to respond to the interactive operation to control the display parameters of the operated object. In FIG. 4, the operated object may be the entire dinosaur.

In some embodiments, when the second control strategy is used to respond to the interactive operation to control the display parameters of the operated object, the second control strategy may include the following exemplary types of controls.

In the first exemplary type of control, the type of interactive operation may be identified, and the display parameters of all objects in the 3D space may be controlled based on the type of interactive operation. When the interactive operation is a gesture interactive operation, the gesture type corresponding to the interactive operation can be identified, and the interactive operation instruction indicated by the interactive operation can be determined such that the display parameters of all objects in the 3D space area can be controlled based on the interactive control instruction.

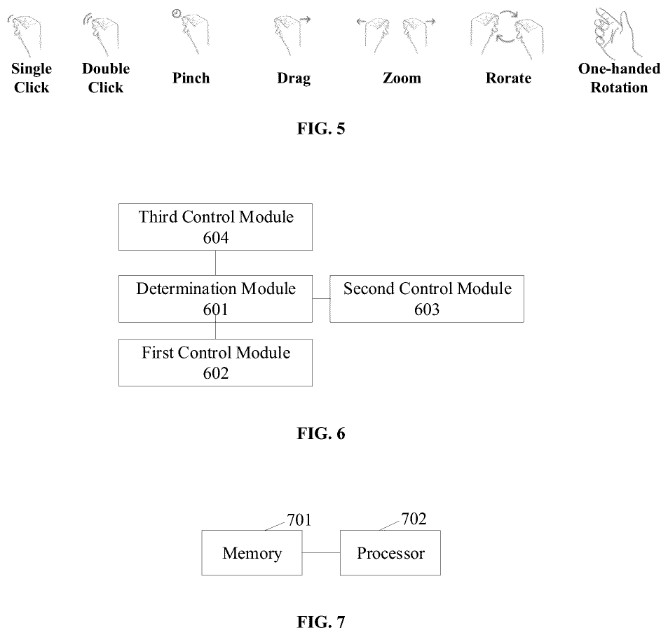

FIG. 5 is a schematic diagram showing some exemplary gesture types according to some embodiments of the present disclosure. The gesture types include at least single click, double click, pinch, drag, zoom, rotate, and one-handed rotate. For example, when the gesture type corresponding to the identified interactive operation is rotation, the interactive control instruction is to rotate all objects. At this time, all objects are controlled to rotate. The rotation in this example belongs to the display attitude, which is a display parameter.

In the second exemplary type of control, the relative position relationship between the action area of the interactive operation and the 3D space area may be determined, and the display parameters of at least part of the objects in the 3D space area may be controlled based on the relative position relationship and the type of the interactive operation. The number of types of interactive operations that the operated object can respond to may be different under different relative position relationships. For example, in the first relative position relationship, the number of types of interactive operations that the operated object can respond to may be 5, and in the second relative position relationship, the number of types of interactive operations that the operated object can respond to may be 3, etc., thereby ensuring the interactive safety of the operated object.

Further, when determining the relative position relationship, a target direction may be first determined, and then the relative position relationship between the action area and the 3D space area may be determined under the target direction. For example, when the target direction is the depth direction, the relative position relationship between the action area and the 3D space area can be determined as a front-back relationship; when the target direction is a parallel direction, the relative position relationship between the action area and the 3D space area can be determined as a left-right relationship.

After the relative position relationship between the action area and the 3D space is determined, the display parameters of at least part of the objects in the 3D space area may be controlled based on the relative position relationship and the type of the interactive operation. For example, when the relative position relationship is the first relative position relationship and the type of the interactive operation is a gesture interaction, it can be determined that the number of types of interactive operations that the operated object can respond to is 4; when the relative position relationship is the second relative position relationship and the type of the interactive operation is a voice interaction, it can be determined that the number of types of interactive operations that the operated object can respond to is 3. In this way, target users can select the action area of the interactive operation based on actual needs, thereby improving the interaction experience.

In the third exemplary type of control, in response to detecting that the target user performs a target interactive operation, a first object in the 3D space may be controlled to be replaced by a second object. In some embodiments, while obtaining the interactive operation, the interactive operation may be analyzed to detect in real time whether the interactive operation is the target interactive operation. The target interactive operation may be pre-set by the target user, such as a cut or swipe operation. At this time, the display of the first object in the 3D space can be changed to the display of the second object. The entire display area in the 3D space area may be controlled to change from displaying the first object to displaying the second object, or part of the display area in the 3D space area may be controlled to change from displaying the first object to displaying the second object, etc.

In some embodiments, the second object may or may not have an association relationship with the first object. In some cases, the association relationship between the second object and the first object may indicate that the second object and the first object belong to the same content source or indicate that the second object and the first object have an association relationship in terms of time sequence or content. In other cases, the second object having no association relationship with the first object may indicate that the second object and the first object belong to different content source or that the second object and the first object have no association relationship in terms of time sequence and content.

Based on the types of controls described above, the second control strategy can be used to respond to the interactive operation to control the display parameters of the operated object, that is, to realize the interactive control of all objects.

In the third control method, if the action area crosses the edge of the visual perception area, a third control strategy may be used to respond to the interactive operation to control the display parameters of the operated object, the third control strategy including the first control strategy, the second control strategy and other control strategies. If it is determined that a part of the action area is within the visual perception area and another part of the action area is outside the visual perception area, the first control strategy may be used to respond to the interactive operation to control part of the object, and the second control strategy may be used to respond to the interactive operation to control the display parameters of all objects. Of course, the operated object can be split to determine the association relationship between the sub-objects obtained by the split. The operated sub-object set may be determined by the association relationship between the sub-objects, and one operated sub-object set may be controlled based on the first control strategy, and another operated sub-object set may be controlled based on the second control strategy, etc.

It should be noted that the embodiments of the present disclosure describe a variety of control strategies, and under different control strategies, the change rate and/or change range of the display parameters may be different. For example, the change rate of the first control strategy can be set to be smaller than the change rate of the second control strategy, the change amplitude of the first control strategy may be set to be larger than the change amplitude of the second control strategy, etc.

In the embodiments of the present disclosure, in order to ensure the safety of the operated object and the interactive operating authority of the target user, after obtaining the interactive operations of at least two operators, the interactive operations of at least two operators may be obtained. More specifically, the display parameters of the operated object can be controlled based on the operator's operating authority to respond to the interactive operations. That is, whether each operator has the corresponding operating authority of the electronic device, or whether the electronic device has the corresponding operating authority of the content source to which the 3D object data is displayed and output can be determined. Subsequently, the display parameters of the operated object can be controlled in response to the interactive operations by the operators with the operating authority.

In some embodiments, the following steps may take place when controlling the display parameters of the operated object in response to the interactive operation based on the operators' operating authority.

Determine whether the operator has the operating authority. If the operator has the operating authority, respond to the interactive operation generated by the operator; if the operator does not have the operating authority, do not respond to the interactive operation generated by the operator.

If all operators have the operating authority, determine the operated objects pointed to by the interactive operation of each operator and determine whether there is a conflict between the operated objects. If the two operated objects are different objects, it may indicate that there is no conflict between the two operated objects. In the case where there is no conflict between the operated objects, the display parameters of each operated object can be controlled respectively. It should be noted that in the case of a conflict between two or more operated objects, the sequence of interactive operation responses may be determined based on the authority level of different operators, the response rate of interactive operations, the priority level of interactive operations, etc., and the control of the display parameters of the operated objects can be responded based on the sequence.

In some embodiments, different operating authorities may be set for different operators with operating authorities. For example, in a classroom scenario, the teacher's operating authority level can be set higher than the student's operating authority level. If the operator's operating authority levels are different, the response to the control of the display parameters of the operated object may be based on the operating authority level. For example, both the teacher and the student have the operating authority level for the operated object. If the teacher and the student perform interactive operations on the operated object at the same time, the teacher's interactive operation will be responded to first to control the display parameters of the operated object. Afterwards, the student's interactive operation will be responded to control the display parameters of the operated object.

In another example, different operators may have different operating authorities. For example, the first operator may operate and control all objects and any single object among all objects, while the second operator may only operate and control all objects and does not have the operating authority to operate and control a single object. Based on this, if the operator's operating authority range is different, the response to the control of the display parameters of the operated object can be based on the operating authority range.

Based on the above method, the security of the operated object and the interactive control authority of the target user can be ensured, and the user experience is high.

In a specific implementation, an electronic device (such as a naked-eye 3D device) can realize 4D linkage, that is, realize video rendering, which may cause changes in the 3D space area that displays and outputs 3D object data. In this case, in response to the target interactive operation, the display parameters of the operated object and the attitude of the associated module of the electronic device can be controlled to change synchronously. For example, in a scenario where the associated module of the electronic device is a screen, while controlling the display parameters of the operated object to change based on the target interactive operation, the screen can also be controlled to change synchronously. In some embodiments, the attitude of the screen may be controlled to change, such as rotating the screen at a certain angle, switching the screen from a flat surface to a curved surface, etc., thereby realizing video rendering and meeting the user's 4D linkage needs.

An embodiment of the present disclosure also provides an electronic device corresponding to the interactive operation method. Since the technical solution provided by the electronic device in the present disclosure is similar to the above-mentioned interactive control method of the present disclosure, for the details of the implementation of the electronic device, reference can be made to the implementation of the interactive control method above, which will not be repeated here.

FIG. 6 is a schematic structural diagram of an exemplary electronic device according to some embodiments of the present disclosure. As shown in FIG. 6, the electronic device includes a determination module 601, a first control module 602, a second control module 603 and a fourth control module 604.

In some embodiments, the determination module 601 may be configured to determine the operated object pointed to by the interactive operation after obtaining the interactive operation of the target user.

In some embodiments, the first control module 602 may be configured to control the display parameters of the operated object with a corresponding control strategy based on the relationship between the action area of the interactive operation and the visual perception area of the target user.

In some embodiments, the visual perception area may be a 3D space area that can be perceived by the target user when the electronic device displays and outputs 3D object data.

In some embodiments, when determining the operated object pointed to by the interactive operation, the determination module 601 may be further configured to implement at least one of the following: obtain coordinate information of the action area of the interactive operation and determine an object in the 3D space area that matches the coordinate information as the operated object; obtain the gesture parameters of the interactive operation and determine all or part of the objects in the 3D space area as the operated objects based on the gesture parameters; when the interactive operation is a voice interactive operation, identify the semantic content of the voice interactive operation and determine an object matching the semantic content in the 3D space area as the operated object.

In some embodiments, when controlling the display parameters of the operated object with a corresponding control strategy based on the relationship between the action area of the interactive operation and the visual perception area of the target user, the first control module 602 may be further configured to implement at least one of the following: use the first control strategy to respond to the interactive operation to control the display parameters of the operated object if the action area is within the visual perception area; use the second control strategy to respond to the interactive operation to control the display parameters of the operated object if the action area is outside the visual perception area; use the third control strategy to respond to the interactive operation to control the display parameters of the operated object if the action area crosses the edge of the visual perception area. In some embodiments, under different control strategies, the change rate and/or change amplitude of the display parameters may be different.

In some embodiments, when using the first control strategy to respond to the interactive operation to control the display parameters of the operated object, the first control module 602 may be further configured to determine the operating variable of the interactive operation based on the operation start point and the operation end point of the interactive operation, and control the operated object to switch from the first display parameter to the second display parameter based on the mapping variable of the operating variable under the first control strategy. The first control module 602 may be also configured to switch the color display parameters of the operated object based on the color selection of the target user or based on the color relationship between the operated object and other related objects if the interactive operation is used to change the color display attribute of the operated object. In addition, the first control module 602 may also be configured to identify the input variable of the voice interactive operation and adjust the display parameters of the operated object based on the input variable if the interactive operation is a voice interactive operation. In some embodiments, the input variable may include at least one of the color display attributes, attitude display attribute, and display size of the operated object.

In some embodiments, when using the first control strategy to respond to the interactive operation to control the display parameters of the operated object, the first control module 602 may also be configured to, when the 3D space outputs a virtual interactive control, if the interactive operation also includes an operation of selecting a target virtual interactive control, adjust the display parameters of the operated object based on the operating variable of the interactive operation and the configuration information of the target virtual interactive control. In some embodiments, the virtual interactive control may be generated based on or not based on the interaction, and/or the virtual interactive control may be updated based on the type of the interactive operation and/or the operated object.

In some embodiments, when using the second control strategy to respond to the interactive operation to control the display parameters of the operated object, the first control module 602 may be configured to identify the type of the interactive operation, and control the display parameters of all objects in the 3D space based on the type of the interactive operation. The first control module 602 may be further configured to determine the relative position relationship between the action area of the interactive operation and the 3D space area, and control the display parameters of at least part of the objects in the 3D space area based on the relative position relationship and the type of the interactive operation. Under different relative position relationships, the number of types of interactive operations that the operated object can respond to may be different. In addition, the first control module 602 may be further configured to, in response to detecting the target user performing a target interactive operation, control the first object in the 3D space area to be replaced with a second object, the second object having or not having an association relationship with the first object.

In some embodiments, the second control module 603 may be configured to, in response to obtaining interactive operations of at least two operators, respond to the interactive operation to control the display parameters of the operated object based on the operator's operating authority.

In some embodiments, when responding to the interactive operation to control the display parameters of the operated object based on the operator's operating authority, the second control module 603 may be configured to not respond to the interactive operation if the operator does not have the operating authority. Further, if the operators all have the operating authority, the operated objects pointed to by the interactive operations of the operators may be determined respectively, and if there is no conflict between the operated objects, the control of the display parameters of the operated objects may be respectively responded to. Furthermore, if the operators have different levels of operating authority, the control of the display parameters of the operated objects may be responded to based on the level of operating authority. In addition, if the operators' operating authority ranges are different, the control of the display parameters of the operated object may be responded to based on the operating authority/range.

In some embodiments, the fourth control module 604 may be configured to, in response to the target interactive operation, control the display parameters of the operated object and the attitude of the associated module of the electronic device to change synchronously.

Consistent with the present disclosure, the operated object can be determined based on the obtained interactive operation, and the corresponding control strategy can be determined based on the relationship between the action area of the interactive operation and the visual perception area of the target user. Subsequently, the display parameters of the operated object can be controlled based on the control strategy. That is, different relationships can correspond to different control strategies. In this way, the purpose of interactive control based on interactive operations can be achieved, and different control strategies can be executed based on different actions and visual perception areas, the interactivity is high. In addition, interactive operations can be performed without physical devices, which reduces the limitations of interaction and improves target users' interactive experience.

An embodiment of the present disclosure also provides an electronic device. FIG. 7 is a schematic structural diagram of another exemplary electronic device according to some embodiments of the present disclosure. As shown in FIG. 7, the electronic device includes a memory 701 and a processor 702. The memory 701 stores a computer program. The processor 702 executes the computer program in the memory 701 to implement the interactive control method according to the embodiments of the present disclosure. In some embodiments, the processor 702 may be configured to perform the following processes.

11, after obtaining the target user's interactive operation, determine the operated object pointed to by the interactive operation.

12, based on the relationship between the action area of the interactive operation and the visual perception area of the target user, control the operated object of the operated object with a corresponding control strategy.

In some embodiments, the visual perception area may be a 3D space area that can be perceived by the target user when the electronic device displays and outputs the 3D object data.

Consistent with the present disclosure, the operated object can be determined based on the obtained interactive operation, and the corresponding control strategy can be determined based on the relationship between the action area of the interactive operation and the visual perception area of the target user. Subsequently, the display parameters of the operated object can be controlled based on the control strategy. That is, different relationships can correspond to different control strategies. In this way, the purpose of interactive control based on interactive operations can be achieved, and different control strategies can be executed based on different actions and visual perception areas, the interactivity is high. In addition, interactive operations can be performed without physical devices, which reduces the limitations of interaction and improves target users' interactive experience.

An embodiment of the present disclosure further provides a storage medium which is a computer-readable storage medium and stores a computer program. When the computer program is executed by a processor, the method provided in the foregoing method embodiments can be implemented. In some embodiments, the processor may be configured to perform the following processes.

21, after obtaining the target user's interactive operation, determine the operated object pointed to by the interactive operation.

22, based on the relationship between the action area of the interactive operation and the visual perception area of the target user, control the operated object of the operated object with a corresponding control strategy.

In some embodiments, the visual perception area may be a 3D space area that can be perceived by the target user when the electronic device displays and outputs the 3D object data.

Consistent with the present disclosure, the operated object can be determined based on the obtained interactive operation, and the corresponding control strategy can be determined based on the relationship between the action area of the interactive operation and the visual perception area of the target user. Subsequently, the display parameters of the operated object can be controlled based on the control strategy. That is, different relationships can correspond to different control strategies. In this way, the purpose of interactive control based on interactive operations can be achieved, and different control strategies can be executed based on different actions and visual perception areas, the interactivity is high. In addition, interactive operations can be performed without physical devices, which reduces the limitations of interaction and improves target users' interactive experience.

In some embodiments, the storage medium may include but is not limited to: a U disk, a read-only memory (ROM), a random-access memory (RAM), a mobile hard disk, a magnetic disk, an optical disk, or suitable media that can store program codes. In some embodiments, the processor executes the processing method described in the embodiments according to the program codes stored in the storage medium. In some embodiments, reference can be made to the examples described in the embodiments and optional implementations, and details will not be described again herein. In some embodiments, those skilled in the art should understand that the above-described modules or steps of the present disclosure can be implemented using general-purpose computing devices, and they can be concentrated on a single computing device, or distributed across a network composed of multiple computing devices. In some embodiments, they may be implemented in program code executable by a computing device, such that they may be stored in a storage device for execution by the computing device, and in some cases, may be in a sequence different from that herein. The steps shown or described are performed either individually as individual integrated circuit modules, or as multiple modules or steps among them as a single integrated circuit module. As such, the present disclosure is not limited to any specific combination of hardware and software.

Furthermore, while the embodiments have been described herein, the scope thereof includes any and all implementations based on the present disclosure that have equivalent elements, modifications, omissions, combinations (e.g., cross-cutting of various embodiments), adaptations, or changes. Elements in the claims are to be construed broadly based on the language employed in the claims and are not limited to the examples described in this specification or during the practice of the present disclosure. The examples are to be construed as non-exclusive. It is intended that the specification and examples be considered as examples only, with a true scope and spirit being indicated by the following claims, along with their full scope of equivalents.

The above description is intended to be illustrative rather than restrictive. For example, the above examples (or one or more versions thereof) may be used in combination with each other. For example, other embodiments may be used by those of ordinary skill in the art upon reading the above description. Additionally, in the above detailed description, various features may be grouped together to simplify the present disclosure. This should not be interpreted as an intention that an unclaimed disclosed feature is essential to any claim. Rather, the subject matter of the present disclosure may lie in less than all features of a particular disclosed embodiment. Thus, the following claims are hereby incorporated into the detailed description as examples or embodiments, with each claim standing on its own as a separate embodiment, and with it being contemplated that these embodiments may be combined with one another in various combinations or permutations. The scope of the present disclosure should be determined with reference to the appended claims, along with the full scope of equivalents to which such claims are entitled.

Various embodiments of the present disclosure have been described in detail above, but the present disclosure is not limited to these specific embodiments. Those skilled in the art can make various variations and modifications to the embodiments based on the concepts of the present disclosure. These variations and modifications all should fall within the protection scope claimed by the present disclosure.

What is claimed is:

1. An interactive control method comprising:
after obtaining a target user's interactive operation, determining an operated object pointed to by the interactive operation; and
based on a relationship between an action area of the interactive operation and a visual perception area of the target user, controlling display parameters of the operated object by a corresponding control strategy, wherein:
the visual perception area is a three-dimensional (3D) space area being perceived by the target user when an electronic device displays and outputs 3D object data.

2. The method of claim 1, wherein determining the operated object pointed to by the interactive operation includes at least one of the following:
obtaining coordinate information of the action area of the interactive operation, and determining an object in the 3D space area that matches the coordinate information as the operated object;
obtaining gesture parameters of the interactive operation, and determining all or part of the objects in the 3D space area as the operated objects based on the gesture parameters; or
when the interactive operation is a voice interactive operation, identifying semantic content of the voice interactive operation, and determining the object matching the semantic content from the 3D space area as the operated object.

3. The method of claim 1, wherein, based on the relationship between the action area of the interactive operation and the visual perception area of the target user, controlling the display parameters of the operated object by the corresponding control strategy includes at least one of the following:
if the action area is within the visual perception area, using a first control strategy to respond to the interactive operation to control of the display parameters of the operated object;
if the action area is outside the visual perception area, using a second control strategy to respond to the interactive operation to control of the display parameters of the operated object; or
if the action area crosses an edge of the visual perception area, using a third control strategy to respond to the interactive operation to control of the display parameters of the operated object;
wherein, a change rate and/or change amplitude of the display parameters being different under different control strategies.

4. The method of claim 3, wherein using the first control strategy to respond to the interactive operation to control of the display parameters of the operated object includes at least one of the following:
determining an operating variable of the interactive operation based on an operation start point and an operation end point of the interactive operation, and controlling the operated object to switch from a first display parameter to a second display parameter based on a mapping variable of the operating variable under the first control strategy;
if the interactive operation is used to change a color display attribute of the operated object, switching a color display parameter of the operated object based on a color selection of the target user or based on a color relationship between the operated object and other related objects; or
when the interactive operation is the voice interactive operation, identifying an input variable of the voice interactive operation, and adjusting the display parameters of the operated object based on the input variable, the input variable including one or more of the color display attribute, an attitude display attribute, and a display size for changing the operated object.

5. The method of claim 3, wherein using the first control strategy to respond to the interactive operation to control of the display parameters of the operated object includes:
when the 3D space outputs a virtual interactive control, if the interactive operation also includes an operation of selecting a target virtual interactive control, adjusting the display parameters of he operated object based on the operation variable of the interactive operation and configuration information of the target virtual interactive control, the virtual interactive being generated based on or not based on the interaction, and/or the virtual interactive control being updated based on a type of the interactive operation and/or the operated object.

6. The method of claim 3, wherein using the second control strategy to respond to the interactive operation to control of the display parameters of the operated object includes at least one of the following:
identifying a type of the interactive operation, and controlling the display parameters of all objects in the 3D space based on the type of the interactive operation;
determining a relative position relationship between the action area of the interactive operation and the 3D space area, and controlling the display parameters of at least part of the objects in the 3D space area based on the relative position relationship and the type of the interactive operation, a number of types of interactive operations the operated object being configured to respond to being different under different relative position relationships; or
in response to detecting the target user performing a target interactive operation, controlling a first object in the 3D space area to be replaced with a second object, the second object having an association relationship with the first object or the second object not having the association relationship with the first object.

7. The method of claim 1 further comprising:
in response to obtaining interactive operations of two or more operators, responding to the interactive operations to control the display parameters of the operated object based on an operating authority of the operators.

8. The method of claim 7, wherein responding to the interactive operations to control the display parameters of the operated object based on the operating authority of the operators includes at least one of the following:
not responding to the interactive operation if the operator does not have the operating authority;
respectively determining the operated object pointed to by each operator's interactive operation if the operators have the operating authority, and respectively responding to the control of the display parameters of each operated object when there is no conflict between the operated objects;
responding to the control of the display parameters of the operated object based on an operating authority level if the operators have different operating authority levels; or
responding to the control of the display parameters of the operated object based on an operating authority range if the operators have different operating authority ranges.

9. The method of claim 1 further comprising:
in response to the target interactive operation, controlling the display parameters of the operated object and an attitude of an associated module of the electronic device to change synchronously.

10. An electronic device comprising:
a determination module, the determination module being configured to determine an operated object pointed to by an interactive operation after obtaining the interactive operation of a target user; and
a first control module, the first control module being configured to control display parameters of the operated object with a corresponding control strategy based on a relationship between an action area of the interactive operation and a visual perception area of the target user, wherein:
the visual perception area is a three-dimensional (3D) space area being perceived by the target user when the electronic device displays and outputs 3D object data.

11. The electronic device of claim 10, wherein the determination module is further configured to execute at least one of the following:
obtain coordinate information of the action area of the interactive operation, and determine an object in the 3D space area that matches the coordinate information as the operated object;
obtain gesture parameters of the interactive operation, and determining all or part of the objects in the 3D space area as the operated objects based on the gesture parameters; or
when the interactive operation is a voice interactive operation, identify semantic content of the voice interactive operation, and determine the object matching the semantic content from the 3D space area as the operated object.

12. The electronic device of claim 10, wherein first control module is further configured to execute at least one of the following:
if the action area is within the visual perception area, use a first control strategy to respond to the interactive operation to control of the display parameters of the operated object;
if the action area is outside the visual perception area, use a second control strategy to respond to the interactive operation to control of the display parameters of the operated object; or
if the action area crosses an edge of the visual perception area, use a third control strategy to respond to the interactive operation to control of the display parameters of the operated object;
wherein a change rate and/or change amplitude of the display parameters being different under different control strategies.

13. The electronic device of claim 12, wherein the first control module is further configured to execute at least one of the following:
determine an operating variable of the interactive operation based on an operation start point and an operation end point of the interactive operation, and control the operated object to switch from a first display parameter to a second display parameter based on a mapping variable of the operating variable under the first control strategy;
if the interactive operation is used to change a color display attribute of the operated object, switch a color display parameter of the operated object based on a color selection of the target user or based on a color relationship between the operated object and other related objects; or
when the interactive operation is the voice interactive operation, identify an input variable of the voice interactive operation, and adjust the display parameters of the operated object based on the input variable, the input variable including one or more of the color display attribute, an attitude display attribute, and a display size for changing the operated object.

14. The electronic device of claim 12, wherein the first control module is further configured to:
when the 3D space outputs a virtual interactive control, if the interactive operation also includes an operation of selecting a target virtual interactive control, adjust the display parameters of he operated object based on the operation variable of the interactive operation and configuration information of the target virtual interactive control, the virtual interactive being generated based on or not based on the interaction, and/or the virtual interactive control being updated based on a type of the interactive operation and/or the operated object.

15. The electronic device of claim 12, wherein the first control module is further configured to execute at least one of the following:
identify a type of the interactive operation, and control the display parameters of all objects in the 3D space based on the type of the interactive operation;
determine a relative position relationship between the action area of the interactive operation and the 3D space area, and control the display parameters of at least part of the objects in the 3D space area based on the relative position relationship and the type of the interactive operation, a number of types of interactive operations the operated object being configured to respond to being different under different relative position relationships; or
in response to detecting the target user performing a target interactive operation, control a first object in the 3D space area to be replaced with a second object, the second object having an association relationship with the first object or the second object not having the association relationship with the first object.

16. The electronic device of claim 10 further comprising:
a second control module, the second control module being configured to: in response to obtaining interactive operations of two or more operators, respond to the interactive operations to control the display parameters of the operated object based on an operating authority of the operators.

17. The electronic device of claim 16, wherein the second control module is further configured to execute at least one of the following:
not respond to the interactive operation if the operator does not have the operating authority;
respectively determine the operated object pointed to by each operator's interactive operation if the operators have the operating authority, and respectively respond to the control of the display parameters of each operated object when there is no conflict between the operated objects;
respond to the control of the display parameters of the operated object based on an operating authority level if the operators have different operating authority levels; or
respond to the control of the display parameters of the operated object based on an operating authority range if the operators have different operating authority ranges.

18. The electronic device of claim 10 further comprising:
a fourth control module, the fourth control module being configured to: in response to the target interactive operation, control the display parameters of the operated object and an attitude of an associated module of the electronic device to change synchronously.

19. An electronic device including one or more processors and a computer readable storage medium storing computer program instructions that, when executed by the one or more processors, causing the electronic device to perform an interactive control method comprising:
after receiving a target user's interactive operation, determining an operated object pointed to by the interactive operation; and
based on a relationship between an action area of the interactive operation and a visual perception area of the target user, controlling display parameters of the operated object by a corresponding control strategy, wherein the visual perception area is a three-dimensional (3D) space area being perceived by the target user when an electronic device displays and outputs 3D object data.

20. The electronic device of claim 19, wherein determining the operated object pointed to by the interactive operation includes at least one of the following:
obtaining coordinate information of the action area of the interactive operation, and determining an object in the 3D space area that matches the coordinate information as the operated object; or
obtaining gesture parameters of the interactive operation, and determining all or part of the objects in the 3D space area as the operated objects based on the gesture parameters; and
when the interactive operation is a voice interactive operation, identifying semantic content of the voice interactive operation, and determining the object matching the semantic content from the 3D space area as the operated object.
